(19) United States
(12) Patent Application Publication
(10) Pub. No.: US 2026/0086385 A1
(43) Pub. Date: Mar. 26, 2026

(54) OPTICAL DEVICE AND LUMINANCE AND COLOR COMPENSATION METHOD

(71) Applicant: Liqxtal Technology Inc., Tainan City (TW)

(72) Inventors: Hung-Shan CHEN, Tainan City (TW); Guo-Lin HU, Tainan City (TW)

(21) Appl. No.: 19/294,251

(22) Filed: Aug. 7, 2025

Related U.S. Application Data
(60) Provisional application No. 63/696,864, filed on Sep. 20, 2024.

(51) Int. Cl. G02B 27/28; G09G 3/34

(52) U.S. Cl. CPC G02B 27/286; G09G 3/3413; G09G 2320/0242; G09G 2320/0646

(57) ABSTRACT

An optical device includes a display device emitting a light and a polarization rotator. The polarization rotator is disposed in front of a light emitting surface of the display device. The polarization rotator includes a wave plate assembly and a back polarizer. The wave plate assembly includes a first quarter-wave plate having an optical axis oriented at a first angle, a first half-wave plate having an optical axis oriented at a second angle, and a second quarter-wave plate having an optical axis oriented at a third angle, in which the first half-wave plate is between the first quarter-wave plate and the second quarter-wave plate, and the second angle is different from the first angle and the third angle. The wave plate assembly is optically coupling between the back polarizer and the display device.

This application claims priority to US Provisional Application Serial Number 63/696,864, filed September 20, 2024, which is herein incorporated by reference in its entirety.

### BACKGROUND

### FIELD OF INVENTION

The present disclosure relates to an optical device and a luminance and color compensation method. More particularly, the present disclosure relates to the optical device including a polarization rotator and the luminance and color compensation method adapted to the optical device.

### DESCRIPTION OF RELATED ART

Displays have been widely applied in various fields, for example, televisions or smart phones with wild fields of view or augmented reality (AR), and virtual reality (VR) or head-up displays (HUD) with narrow fields of view.

In display applications with narrow fields of view, a display device and an optic module are usually integrated in a cavity. The output light passing through the optic module therefore enters the human eyes. However, portions of output light from the display device would strike the sidewalls of the cavity before entering the human eyes, resulting in so-called “stray light,” which degrades image quality and affects the user experience. Therefore, there is a need to solve the above problems.

### SUMMARY

The optical device of the present disclosure includes a polarization rotator. The polarization rotator includes a plurality of wave plates to optimize a polarization conversion efficiency of the polarization rotator, such that the image quality of the optical device can be improved and the user experience can be enhanced.

The luminance and color compensation method adapted to the optical device of the present disclosure optimizes the brightness uniformity and color shift of the light emitted from the display device, such that the image quality of the optical device can be improved and the user experience can be enhanced.

One aspect of the present disclosure is to provide an optical device including a display device emitting a light and a polarization rotator. The polarization rotator is disposed in front of a light emitting surface of the display device. The polarization rotator includes a wave plate assembly and a back polarizer. The wave plate assembly includes a first quarter-wave plate having an optical axis oriented at a first angle, a first half-wave plate having an optical axis oriented at a second angle, and a second quarter-wave plate having an optical axis oriented at a third angle, in which the first half-wave plate is between the first quarter-wave plate and the second quarter-wave plate, and the second angle is different from the first angle and the third angle. The wave plate assembly is optically coupling between the back polarizer and the display device.

In some embodiments of the present disclosure, the polarization rotator further includes a front polarizer optically coupling between the display device and the wave plate assembly.

In some embodiments of the present disclosure, an angle of a transmittance axis of the back polarizer added by 90 degrees is substantially equal to an angle of a transmittance axis of the front polarizer added by the first angle and the third angle.

In some embodiments of the present disclosure, the light emitted from the display device is unpolarized.

In some embodiments of the present disclosure, the light emitted from the display device is polarized, and an angle of a transmittance axis of the back polarizer added by 90 degrees is substantially equal to an angle of a polarization direction of the light emitted from the display device added by the first angle and the third angle.

In some embodiments of the present disclosure, a difference between the first angle and the second angle is in a range from about 40 degrees to about 50 degrees, and a difference between the second angle and the third angle is in a range from about 40 degrees to about 50 degrees.

In some embodiments of the present disclosure, a difference between the first angle and the second angle is substantially equal to a difference between the second angle and the third angle.

In some embodiments of the present disclosure, the first angle is substantially equal to the third angle.

In some embodiments of the present disclosure, the wave plate assembly further includes a wave plate optically coupling the first quarter-wave plate, the first half-wave plate, and the second quarter-wave plate to the back polarizer.

In some embodiments of the present disclosure, the wave plate is a second half-wave plate having an optical axis oriented at a fourth angle different from the first angle, the second angle, and the third angle.

In some embodiments of the present disclosure, the light passing through the polarization rotator has a first phase retardation at a first wavelength and a second phase retardation at a second wavelength different from the first wavelength, the first wavelength and the second wavelength are in a range from about 400 nm to about 700nm, and a difference between the first phase retardation and the second phase retardation is less than about 10 degrees.

In some embodiments of the present disclosure, the optical device further includes an optic module, in which the wave plate assembly optically couples between the optic module and the display device.

In some embodiments of the present disclosure, the light through the polarization rotator has a linear state of polarization.

In some embodiments of the present disclosure, the back polarizer is a linear polarizer.

In some embodiments of the present disclosure, the back polarizer is a circular polarizer.

In some embodiments of the present disclosure, the light through the polarization rotator has a circular state of polarization.

In some embodiments of the present disclosure, an in-plane retardation (R0) of each of the first quarter-wave plate and the second quarter-wave plate is in a range from 70 nm to 75 nm for wavelength 550 nm, and an in-plane retardation (R0) of the first half-wave plate is in a range from 140 nm to 150 nm for wavelength 550 nm.

In some embodiments of the present disclosure, the polarization rotator is in contact with the light emitting surface of the display device.

One aspect of the present disclosure is to provide a luminance and color compensation method, adapted to an optical device including a display device and a polarization rotator in front of a light emitting surface of the display device, in which the polarization rotator has a first rotator area and a second rotator area, the display device includes a backlight module and a display panel, and the backlight module includes a first backlight area corresponding to the first rotator area of the polarization rotator and a second backlight area corresponding to the second rotator area of the polarization rotator, the method including: emitting a light from the backlight module to the display panel, in which the first backlight area of the backlight module has a first backlight luminance and the second backlight area of the backlight module has a second backlight luminance different from the first backlight luminance; and directing the light from the display panel to the polarization rotator, in which the light exiting the polarization rotator has a first luminance in the first rotator area of the polarization rotator and has a second luminance in the second rotator area of the polarization rotator, in which a ratio of a difference between the first luminance and the second luminance to the first luminance is less than a ratio of a difference between the first backlight luminance and the second backlight luminance to the first backlight luminance.

In some embodiments of the present disclosure, the display panel includes a first panel area corresponding to the first rotator area of the polarization rotator and a second panel area corresponding to the second rotator area of the polarization rotator, and the method further includes: controlling the display panel such that the first panel area has a first color shift and the second panel area has a second color shift different from the first color shift, in which the light exiting the first rotator area and the second rotator area of the polarization rotator has a greater brightness uniformity than a color uniformity of the light exiting the first panel area and the second panel area of the display panel.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic cross-sectional view of an optical device in accordance with some embodiments of the present disclosure.

FIG. 2 is a schematic three-dimensional view of a first embodiment of the optical device in FIG. 1.

FIG. 3A is a schematic view of a first example of the optical device in FIG. 2.

FIG. 3B is a schematic view of an example of a comparative optical device.

FIG. 3C is a line chart showing phase retardations of lights in the optical device in FIG. 3A and the comparative optical device in FIG. 3B.

FIG. 4 is a schematic view of a second example of the optical device in FIG. 2.

FIG. 5 is a schematic three-dimensional view of a second embodiment of the optical device in FIG. 1.

FIG. 6A is a schematic view of an example of the optical device in FIG. 5.

FIG. 6B is a diagram showing transmittance at different polar angles and azimuth angles of the example of the optical device in FIG. 6A.

FIG. 6C is a diagram showing Cx change value of white color at different polar angles and azimuth angles of the example of the optical device in FIG. 6A.

FIG. 6D is a diagram showing Cy change value of white color at different polar angles and azimuth angles of in the example of the optical device in FIG. 6A.

FIG. 6E is a line chart showing a relationship between average transmittance and polar angle for different thicknesses of the second half-wave plate in the example of the optical device in FIG. 6A.

FIG. 6F is a line chart showing a relationship between brightness uniformity and thicknesses of the second half-wave plate in the example of the optical device in FIG. 6A.

FIG. 7 is a schematic three-dimensional view of a third embodiment of the optical device in FIG. 1.

FIG. 8A is a schematic view of a first example of the optical device in FIG. 7.

FIG. 8B is a schematic view of a second example of the optical device in FIG. 7.

FIG. 9 is a schematic cross-sectional view of an optical device in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed.

It will be understood that, although the terms “first,” “second,” etc. may be used herein to describe various elements, these elements should not be limited by these terms. These terms are only used to distinguish one element from another. For example, a “first element” may be termed a “second element,” and, similarly, a “second element” may be termed a “first element,” without departing from the scope of the embodiments. As used herein, the term "and/or" includes any and all combinations of one or more of the associated listed items.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean ±20% of the stated value, more typically ±10% of the stated value, more typically ±5% of the stated value, more typically ±3% of the stated value, more typically ±2% of the stated value, more typically ±1% of the stated value and even more typically ±0.5% of the stated value. The stated value of the present disclosure is an approximate value. That is, when there is no specific description of the terms “about,” “approximately” and “substantially”, the stated value includes the meaning of “about,” “approximately” or “substantially”.

In some cases, an optical device is equipped with a single half-wave plate for reducing the stray light in the optical device. However, such optical device may have poor brightness uniformity and poor color uniformity.

In some embodiments of the present disclosure, an optical device is equipped with a wave plate assembly including a plurality of stacked wave plates to improve the brightness uniformity and the color uniformity of the disclosed optical device, such that the image quality of the optical device can be improved and the user experience can be enhanced.

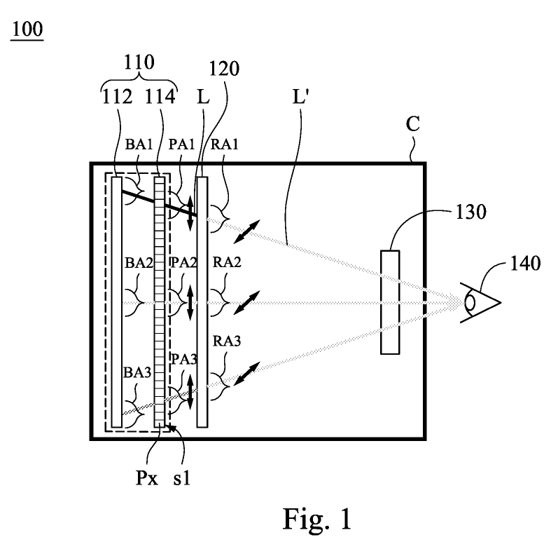

FIG. 1 is a schematic cross-sectional view of an optical device 100 in accordance with some embodiments of the present disclosure. The optical device 100 includes a display device 110 and a polarization rotator 120. The display device 110 emits a light L to the polarization rotator 120. The polarization rotator 120 is disposed in front of a light emitting surface s1 of the display device 110. The polarization rotator 120 is configured to receive the light emitted from the display device 110.

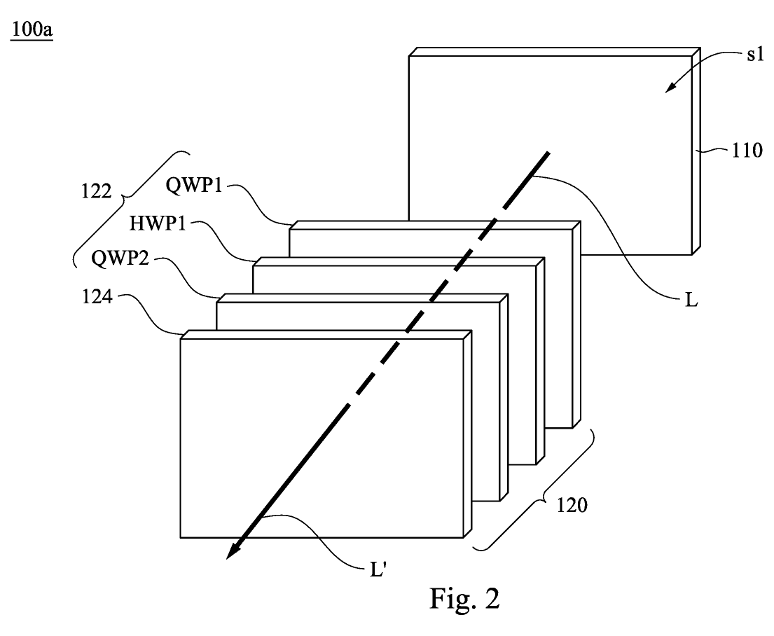

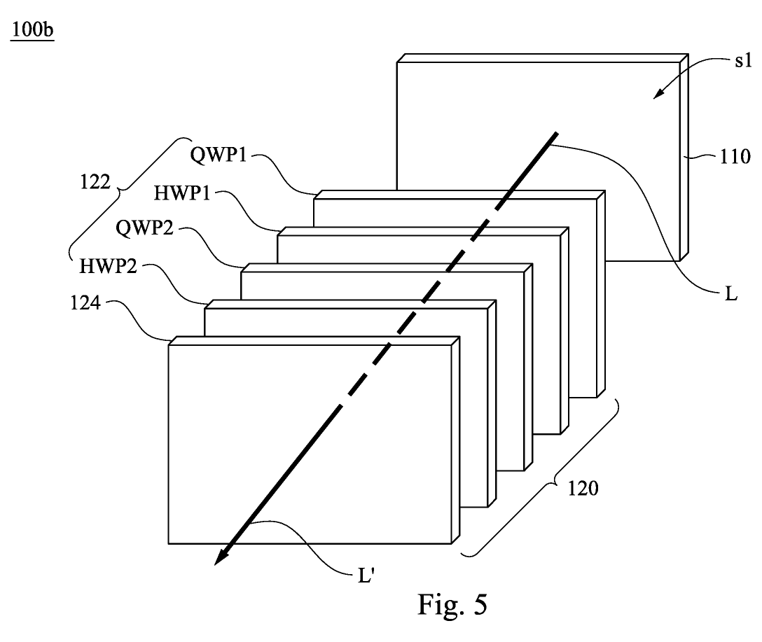

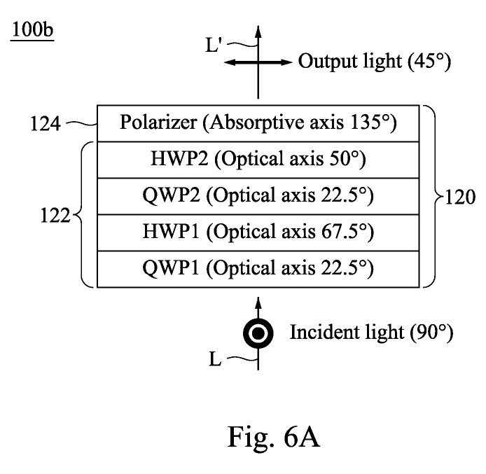

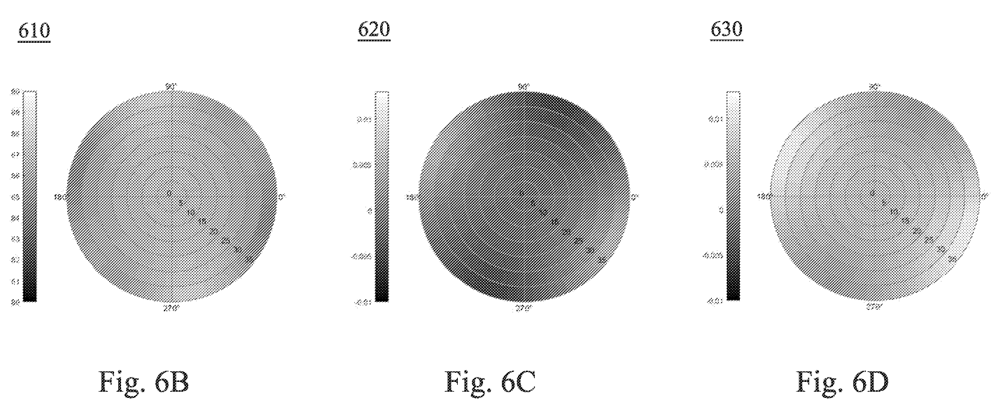

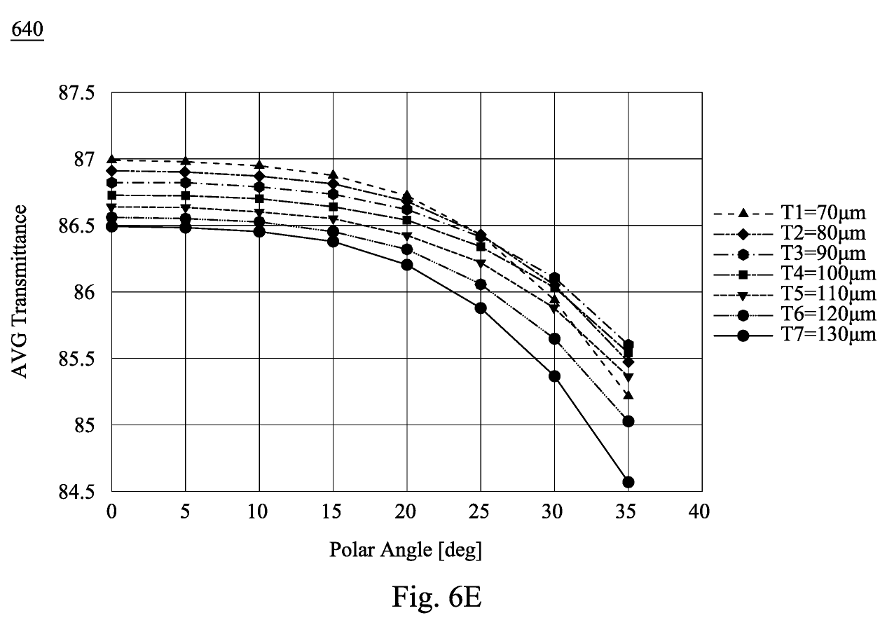

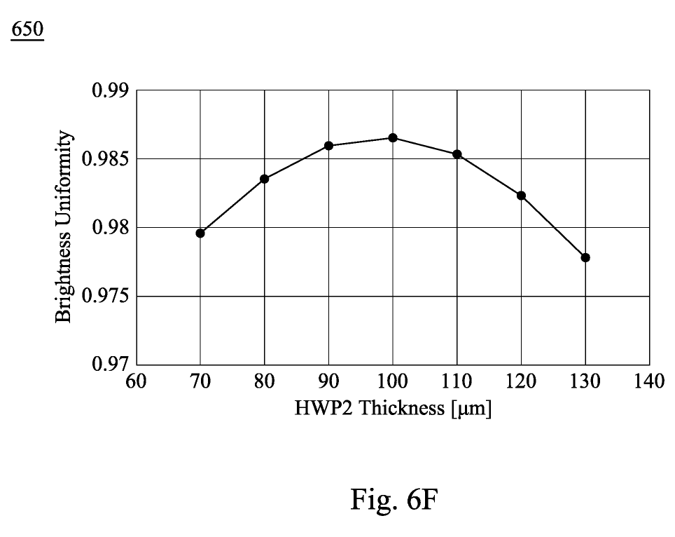

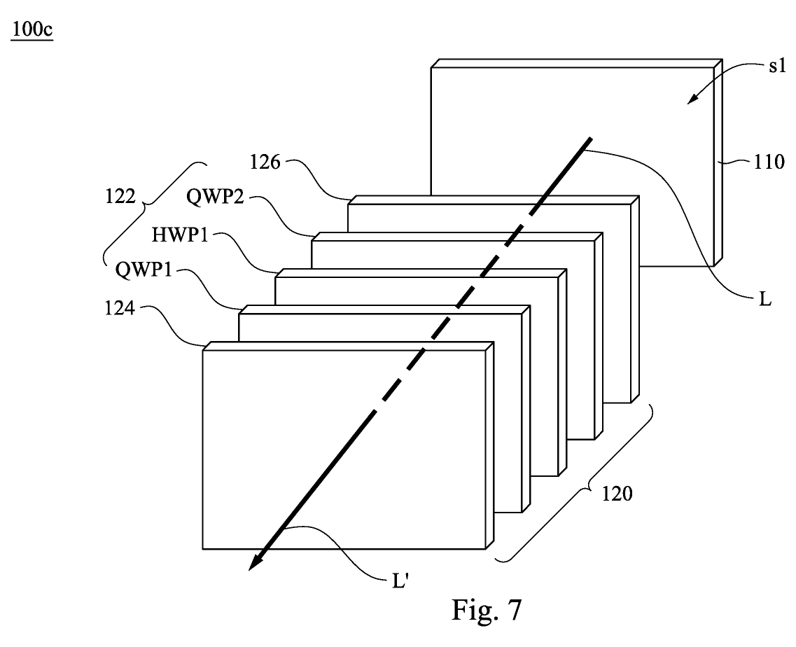

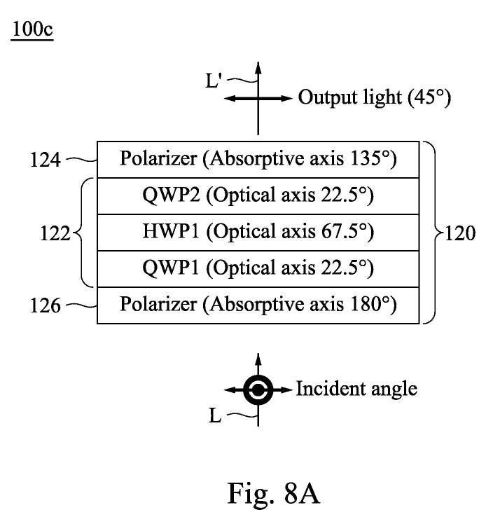

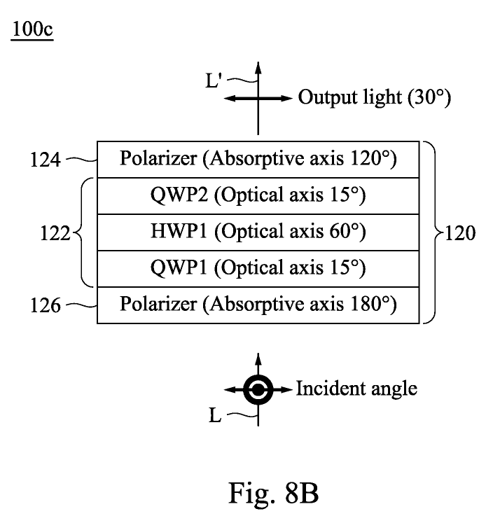

In the present disclosure, the optical device 100 is illustrated by three embodiments, which are optical devices 100a shown in FIGS. 2, 3A and 4, optical devices 100b shown in FIGS. 5 and 6A, and optical devices 100c shown in FIGS. 7, 8A and 8B. Embodiments of the optical devices 100 of the present disclosure will be described in detail below.

FIG. 2 is a schematic three-dimensional view of a first embodiment of the optical device 100 in FIG. 1. In the embodiments of FIG. 2, the light L emitted from the display device 110 is polarized. An optical device 100a in FIG. 2 includes the display device 110 and a polarization rotator 120. The polarization rotator 120 includes a wave plate assembly 122 and a back polarizer 124. The wave plate assembly 122 optically couples between the back polarizer 124 and the display device 110. The wave plate assembly 122 includes a first quarter-wave plate QWP1 having an optical axis oriented at a first angle, a first half-wave plate HWP1 having an optical axis oriented at a second angle, and a second quarter-wave plate QWP2 having an optical axis oriented at a third angle. The first half-wave plate HWP1 is between the first quarter-wave plate QWP1 and the second quarter-wave plate QWP2. In some embodiments, the second angle is different from the first angle and the third angle. It could be understood that the first quarter-wave plate QWP1, the first half-wave plate HWP1, and the second quarter-wave plate QWP2 can be referred to as the “stacked wave plates.”

The term “optical axis” in the present disclosure may be the fast axis (e.g., corresponding to the optical axis of orientation for the wave plate assembly 122 including a negative uniaxial material) or the slow axis (e.g., corresponding to the optical axis of orientation for the wave plate assembly 122 including a positive uniaxial material), or some other axis by which the retarding elements are oriented relative to each other. The term “angle” of a polarization direction of the light L in the present disclosure is located on a plane perpendicular to propagation direction of the light L.

In some embodiments, a difference between the first angle and the second angle is in a range from about 40 degrees to about 50 degrees, such as, 42.5 degrees, 45 degrees, or 47.5 degrees. In some embodiments, a difference between the second angle and the third angle is in a range from about 40 degrees to about 50 degrees, such as, 42.5 degrees, 45 degrees, or 47.5 degrees. In some embodiments, a difference between the first angle and the second angle is substantially equal to a difference between the second angle and the third angle. For example, the first angle is substantially equal to the third angle.

In some embodiments, one or more of the first quarter-wave plate QWP1, the first half-wave plate HWP1, and the second quarter-wave plate QWP2 is an active waveplate, such as an electro-optic wave plate (e.g., a liquid crystal wave plate), an acousto-optic wave plate, or a magneto-optic wave plate. In some embodiments, one or more of the first quarter-wave plate QWP1, the first half-wave plate HWP1, and the second quarter-wave plate QWP2 is a passive waveplate, such as a uniaxial crystal, a biaxial crystal, or a liquid crystal polymer film. In some embodiments, the first half-wave plate HWP1 may be formed by two quarter-wave plates.

Reference is made back to FIG. 1. The display device 110 is a liquid crystal display (LCD), an organic light emitting diode (OLED) display, or a micro light emitting diode (micro LED) display, or other suitable displays. In some embodiments, the display device 110 includes a backlight module 112 and a display panel 114 on an emitting surface of the backlight module 112. In some embodiments, the backlight module 112 may include a controller configured to locally control the intensity of the light emitted from the backlight module 112. Stated differently, the backlight module 112 can be operated by locally adjusting the brightness of the backlight module 112. The display panel 114 includes a plurality of pixels Px, in which the color and brightness of the pixels Px can be controlled independently.

Referring to FIG. 1, in some embodiments, the optical device 100 further includes an optic module 130, in which the wave plate assembly 122a optically couples between the optic module 130 and the display device 110. The optic module 130 may be considered as an “optics black box” (e.g., a device which can be viewed in terms of its inputs and outputs) that may convert linearly polarized light to circularly polarized light in a range (e.g., visible range) of wavelengths. It could be understood that the light L’ may pass through the optic module 130 and then enters human eyes 140.

It could be understood that the display device 110, the polarization rotator 120, and the optic module 130 are integrated in a cavity C, as shown in FIG. 1. In some embodiments, the polarization rotator 120 is in contact with the light emitting surface s1 of the display device 110. For example, the polarization rotator 120 may be adhered to the light emitting surface s1 of the display device 110. In some embodiments, the optical device 100 shown in FIG. 1 further includes other elements in the cavity C, and the polarization rotator 120 is in contact with the any one of these elements. In some embodiments, the polarization rotator 120 may be independently located on an optical path of the optical device 100 shown in FIG. 1.

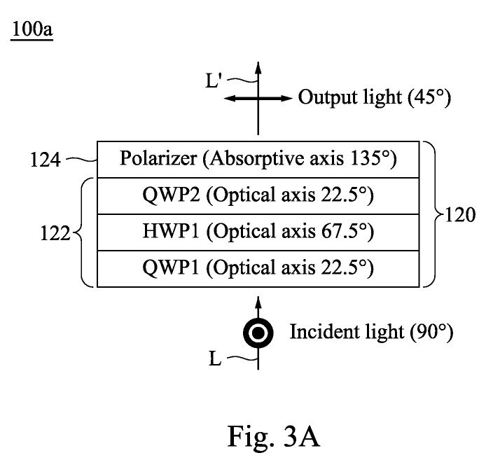

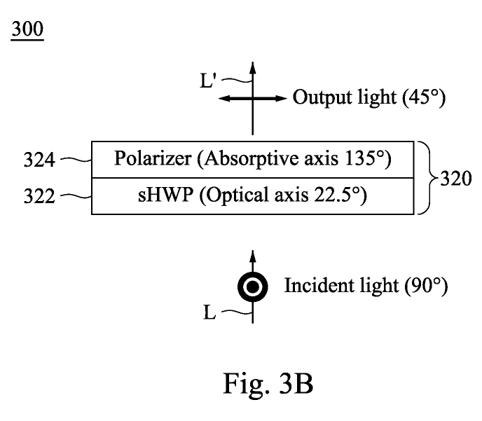

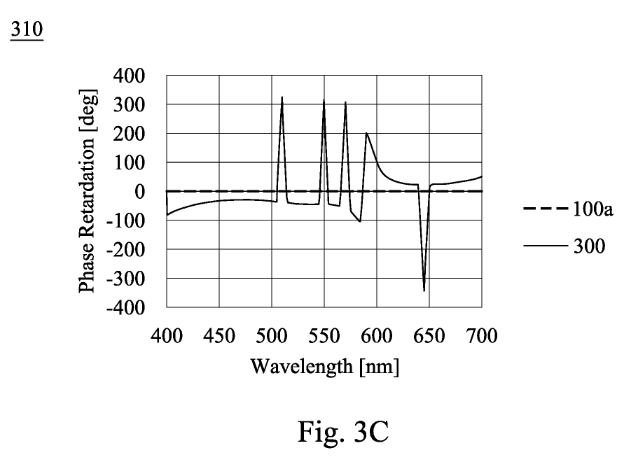

FIG. 3A is a schematic view of a first example of the optical device 100a in FIG. 2. The display device 110a may provide a polarized incident light L to the polarization rotator 120, and the polarized incident light L entering the polarization rotator 120 is output as an output light L’ as shown in FIG. 3A. In the first example of the optical device 100a, the incident light L having a linear polarization direction oriented at 90 degrees is rotated by the polarization rotator 120, thereby generating the output light L’ having a linear polarization direction oriented at 45 degrees. In the first example of the optical device 100a in FIG. 3A, for achieving polarization rotation from 90 degrees to 45 degrees, in the wave plate assembly 122, the first angle that the optical axis of the first quarter-wave plate QWP1 is oriented at about 22.5 degrees, the second angle that the optical axis of the first half-wave plate HWP1 is oriented at is about 67.5 degrees, and the third angle that the optical axis of the second quarter-wave plate QWP2 is oriented at is about 22.5 degrees.

In the first example of the optical device 100a in FIG. 3A, an angle (i.e., 45 degrees) of the transmittance axis of the back polarizer 124 added by 180 degrees is substantially equal to the angle (i.e., 90 degrees) of the polarization direction of the light (i.e., the incident light L) emitted from the display device 110 (referring to FIG. 2) added by the first angle (i.e., 22.5 degrees), the third angle (i.e., 22.5 degrees), and 90 degrees. With this configuration, the incident light L having a polarization direction oriented at 90 degrees is rotated by the polarization rotator 120 by about 135 degrees, thereby generating the output light L’ having a polarization direction oriented at 45 degrees.

In the first example of the optical device 100a in FIG. 3A, an angle of an absorptive axis of the back polarizer 124 is 135 degrees (i.e., an angle of a transmittance axis of the back polarizer 124 is 45 degrees). Through the configuration, the output light L’ having a linear polarization state can pass the back polarizer 124, in which a polarization direction of the output light L’ is oriented at 45 degrees.

For achieving polarization rotation from 90 degrees to 45 degrees, the angle of the transmittance axis of the back polarizer 124 added by 90 degrees (i.e., an angle of an absorptive axis of the back polarizer 124) is substantially equal to the angle of a polarization direction of the light L emitted from the display device 110 added by the first angle and the third angle.

In some embodiments, the back polarizer 124 is an absorptive polarizer or a reflective polarizer. The back polarizer 124 may be a linear polarizer, a left-handed circular polarizer, a right-handed circular polarizer, or a z-polarizer.

FIG. 3B is a schematic view of an example of a comparative optical device 300. The comparative optical device 300 includes a polarization rotator 320. The polarization rotator 320 includes a single half-wave plate (sHWP) 322 and a back polarizer 324. The incident light L in FIG. 3B is linearly polarized with a polarization direction oriented at 90 degrees. The single half-wave plate 322 has an optical axis oriented at 22.5 degrees. With this single half-wave plate 322, the incident light L having a polarization direction oriented at 90 degrees is rotated by the single half-wave plate 322 by about 135 degrees, thereby generating the output light L’ having a polarization direction oriented at 45 degrees. In the example of the comparative optical device 300 in FIG. 3B, the back polarizer 324 is a linear polarizer. An angle of an absorptive axis of the back polarizer 423 is 135 degrees, thereby allowing an output light L’ having a linear polarization state with a polarization direction oriented at 45 degrees to pass the back polarizer 324.

FIG. 3C is a line chart 310 showing phase retardations of lights in the optical device 100a in FIG. 3A and the comparative optical device 300 in FIG. 3B. In FIG. 3C, a dashed line represents the phase retardation of the output light L’ from the optical device 100a in FIG. 3A and the solid line represents the phase retardation of the output light L’ from the comparative optical device 300 in FIG. 3B. The polarization rotator 120 of the optical device 100a in FIG. 3A can adjust the phase retardation of the light L, such that the phase retardation of the output light L’ at different wavelengths remains steady.

FIG. 3C shows that the phase retardation of the output light L’ from the optical device 100a remains about 0 degrees at the wavelengths ranging from 400 nm to 700 nm, but the phase retardation of the output light L’ from the comparative optical device 300 varies at different wavelengths. It is understood that the homogeneous phase retardations can result in the brightness uniformity and the color uniformity of the optical device, thereby improving the image quality of the optical device and enhancing the user experience. Therefore, the optical device 100a in FIG. 3A has better brightness uniformity and color uniformity than the comparative optical device 300 in FIG. 3B.

For the optical device 100a, a light L’ passing through the polarization rotator 120 (referring to FIG. 3A) has a first phase retardation at a first wavelength and a second phase retardation at a second wavelength different from the first wavelength, the first wavelength and the second wavelength are in a range from about 400 nm to about 700nm, and a difference between the first phase retardation and the second phase retardation is less than about 10 degrees, such as 2, 5, or 8 degrees. This indicates that the phase retardation of the output light L’ at different wavelengths remains steady.

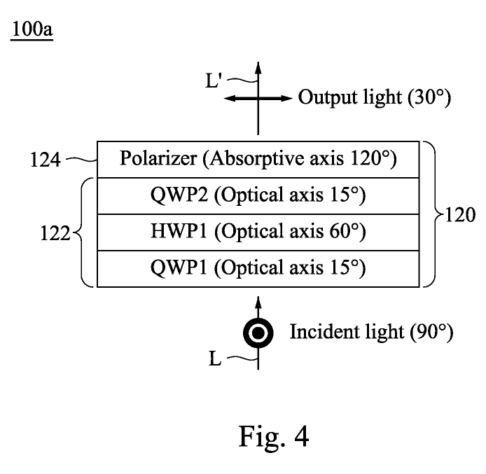

FIG. 4 is a schematic view of a second example of the optical device100a in FIG. 2. Details of the present example are similar to the example of FIG. 3A, except that the incident light L having a linear polarization direction oriented at 90 degrees is rotated by the polarization rotator 120, thereby generating the output light L’ having a linear polarization direction oriented at 30 degrees. In the second example of the optical device 100a in FIG. 4, for achieving polarization rotation from 90 degrees to 30 degrees, in the wave plate assembly 122, the first angle that the optical axis of the first quarter-wave plate QWP1 is oriented at about 15 degrees, the second angle that the optical axis of the first half-wave plate HWP1 is oriented at is about 60 degrees, and the third angle that the optical axis of the second quarter-wave plate QWP2 is oriented at is about 15 degrees.

In the second example of the optical device 100a in FIG. 4, an angle (i.e., 30 degrees) of the transmittance axis of the back polarizer 124 added by 180 degrees is substantially equal to the angle (i.e., 90 degrees) of the polarization direction of the light (i.e., the incident light L) emitted from the display device 110 (referring to FIG. 2) added by the first angle (i.e., 15 degrees), the third angle (i.e., 22.5 degrees), and 90 degrees. With this configuration, the incident light L having a polarization direction oriented at 90 degrees is rotated by the polarization rotator 120 by about 120 degrees, thereby generating the output light L’ having a polarization direction oriented at 30 degrees.

In the second example of the optical device 100a in FIG. 4, an angle of an absorptive axis of the back polarizer 124 is 120 degrees (i.e., an angle of a transmittance axis of the back polarizer 124 is 30 degrees). Through the configuration, the output light L’ having a linear polarization state can pass the back polarizer 124, in which a polarization direction of the output light L’ is oriented at 30 degrees.

For achieving polarization rotation from 90 degrees to 30 degrees, the angle of the transmittance axis of the back polarizer 124 added by 90 degrees (i.e., angle of a transmittance axis of the back polarizer 124) is substantially equal to the angle of a polarization direction of the light L emitted from the display device 110 added by the first angle and the third angle.

FIG. 5 is a schematic three-dimensional view of a second embodiment of the optical device 100 in FIG. 1. The optical device 100b in FIG. 5 is similar to the optical device 100a in FIG. 2, except that the wave plate assembly 122 of the optical device 100b further includes a wave plate (e.g., a second half-wave plate HWP2) between the second quarter-wave plate QWP2 and the back polarizer 124 for optically coupling the first quarter-wave plate QWP1, the first half-wave plate HWP1, and the second quarter-wave plate QWP2 to the back polarizer 124. It could be understood that the first quarter-wave plate QWP1, the first half-wave plate HWP1, the second quarter-wave plate QWP2, and second half-wave plate HWP2 can be referred to as the “stacked wave plates.”

In some embodiments, the second quarter-wave plate QWP2 is an active waveplate, such as an electro-optic wave plate (e.g., a liquid crystal wave plate), an acousto-optic wave plate, or a magneto-optic wave plate. In some embodiments, the second quarter-wave plate QWP2 is a passive waveplate, such as a uniaxial crystal, a biaxial crystal, or a liquid crystal polymer film. In some embodiments, the second half-wave plate HWP2 may be formed by two quarter-wave plates. Other details of the embodiment of FIG. 5 are similar to that of the embodiment of FIG. 2, and thereto not repeated herein.

FIG. 6A is a schematic view of an example of the optical device 100b in FIG. 5. The optical device 100b in FIG. 6A is similar to the optical device 100a in FIG. 3A. In the example of the optical device 100b in FIG. 6A, the incident light L having a linear polarization direction oriented at 90 degrees is rotated by the polarization rotator 120, thereby generating the output light L’ having a linear polarization direction oriented at 45 degrees. The first quarter-wave plate QWP1, the first half-wave plate HWP1, the second quarter-wave plate QWP2, and the back polarizer 124 in FIG. 6A may be the same as the first quarter-wave plate QWP1, the first half-wave plate HWP1, the second quarter-wave plate QWP2, and the back polarizer 124 in FIG. 3A, and the details thereof are not repeatedly described. In the wave plate assembly 122, the second half-wave plate HWP2 has an optical axis oriented at a fourth angle different from the first angle, the second angle, and the third angle.

For achieving polarization rotation from 90 degrees to 45 degrees, in the wave plate assembly 122, the first angle that the optical axis of the first quarter-wave plate QWP1 is oriented at about 22.5 degrees, the second angle that the optical axis of the first half-wave plate HWP1 is oriented at is about 67.5 degrees, the third angle that the optical axis of the second quarter-wave plate QWP2 is oriented at is about 22.5 degrees, and the fourth angle that the optical axis of the second half-wave plate HWP2 is oriented at is about 50 degrees.

The second half-wave plate HWP2 of the optical device 100b may slightly tune the polarization direction of the light passing through the second quarter-wave plate QWP2, such that the output light L’ having a linear polarization state can pass the back polarizer 124, in which a polarization direction of the output light L’ is oriented at 45 degrees. In some embodiments, a difference between the fourth angle that the optical axis of the second half-wave plate HWP2 and the angle of the polarization direction of the output light L’ is in a range from about 1 degree to about 10 degrees.

FIG. 6B is a diagram 610 showing transmittance at different polar angles and azimuth angles of the example of the optical device 100b in FIG. 6A. In a specific embodiment of the second half-wave plate HWP2, R0 value is 130 nm at the wavelength of 450 nm, R0 value is 145 nm at the wavelength of 550 nm, and R0 value is 150 nm at the wavelength of 650 nm. As shown in FIG. 6B, the transmittance of the optical device 100b with the specific second half-wave plate HWP2 is uniform at polar angles ranging from 0 degree to 35 degrees. Therefore, the optical device 100b in FIG. 6A has better brightness uniformity compared with the comparative optical device 300 in FIG. 3B.

FIG. 6C is a diagram 620 showing Cx change value of white color at different polar angles and azimuth angles of the example of the optical device 100b in FIG. 6A. FIG. 6D is a diagram 630 showing Cy change value of white color at different polar angles and azimuth angles of the example of the optical device 100b in FIG. 6A. As shown in FIGS. 6C and 6D, the Cx and Cy change values of white color of the optical device 100b with the specific second half-wave plate HWP2 are uniform at polar angles ranging from 0 degree to 35 degrees. Therefore, the optical device 100b in FIG. 6A has better color uniformity compared with the comparative optical device 300 in FIG. 3B.

FIG. 6E is a line chart 640 showing a relationship between average transmittance and polar angle for different thicknesses T1~T7 of the second half-wave plate HWP2 in the example of the optical device 100b in FIG. 6A. In a specific embodiment of the second half-wave plate HWP2, a difference in refractive indices between the X-axis and Y-axis (nx-ny) is 0.002368 at the wavelength of 450 nm, a difference in refractive indices between the X-axis and Y-axis (nx-ny) is 0.002637 at the wavelength of 550 nm, and a difference in refractive indices between the X-axis and Y-axis (nx-ny) is 0.002737 at the wavelength of 650 nm. As shown in FIG. 6E, in comparison with the second half-wave plates HWP2 with thicknesses of less than 90 µm or greater than 110 µm, the second half-wave plates HWP2 with thicknesses ranging from 90 µm to 110 µm have better average transmittance at polar angles ranging from 0 degrees to 35 degrees.

.FIG. 6F is a line chart 650 showing a relationship between brightness uniformity and thicknesses of the second half-wave plate HWP2 in the example of the optical device in FIG. 6A. As shown in FIG. 6F, in comparison with the second half-wave plates HWP2 with thicknesses of less than 90 µm or greater than 110 µm, the second half-wave plates HWP2 with thicknesses ranging from 90 µm to 110 µm have better brightness uniformity at polar angles ranging from 0 degree to 35 degrees.

In some embodiments, an in-plane retardation (R0) of each of the first quarter-wave plate QWP1 and the second quarter-wave plate QWP2 is in a range from 70 nm to 75 nm for wavelength 550 nm, and an in-plane retardation (R0) of the first half-wave plate HWP1 is in a range from 140 nm to 150 nm for wavelength 550 nm. If the above R0 value of each of quarter-wave plate is in a range from 70 nm to 75 nm, and the above R0 value of each of half-wave plate is in a range from 140 nm to 150 nm, the optical device 100 has better average transmittance and color uniformity, such that the image quality of the optical device 100 can be improved and the user experience can be enhanced.

In some embodiments, a field of view (FOV) of the light through the optic module 130 (referring to FIG. 1) is in a range from 0 degree to 35 degrees, such as 10 degrees, 15 degrees, 20 degrees, 25 degrees, or 30 degrees.

FIG. 7 is a schematic three-dimensional view of a third embodiment of the optical device 100 in FIG. 1. The optical device 100c in FIG. 7 is similar to an optical device 100a in FIG. 2, except that the optical device 100c in FIG. 7 further includes a front polarizer 126 between the wave plate assembly 122 and the display device 110 for optically coupling between the display device 110 and the wave plate assembly 122. The display device 110c may provide an unpolarized incident light L to the polarization rotator 120, and the unpolarized incident light L entering the polarization rotator 120 is output as an output light L’ as shown in FIG. 7. Other details of the embodiment of FIG. 7 are similar to those in the embodiment of FIG. 2, and thereof not repeatedly described.

In some embodiments, the front polarizer 126 is an absorptive polarizer or a reflective polarizer. The front polarizer 126 may be a linear polarizer, a left-handed circular polarizer, a right-handed circular polarizer, or a z-polarizer.

FIG. 8A is a schematic view of a first example of the optical device 100c in FIG. 7. The optical device 100c in FIG. 8A is similar to the optical device 100a in FIG. 3A, except that an unpolarized incident light L is provided to the polarization rotator 120, and the optical device 100c further includes a front polarizer 126 having a linear polarization direction oriented at 90 degrees.

In the first example of the optical device 100c in FIG. 8A, an angle of an absorptive axis of the front polarizer 126 is 180 degrees (i.e., an angle of a transmittance axis of the front polarizer 126 is 90 degrees). The first quarter-wave plate QWP1, the first half-wave plate HWP1, the second quarter-wave plate QWP2, and the back polarizer 124 in FIG. 8A may be the same as the first quarter-wave plate QWP1, the first half-wave plate HWP1, the second quarter-wave plate QWP2, and the back polarizer 124 in FIG. 3A, and the details thereof are not repeatedly described.

FIG. 8B is a schematic view of a second example of the optical device 100c in FIG. 7, except that an unpolarized incident light L is provided to the polarization rotator 120, and the optical device 100c further includes a front polarizer 126 having a linear polarization direction oriented at 90 degrees.

In the first example of the optical device 100c in FIG. 8B, an angle of an absorptive axis of the front polarizer 126 is 180 degrees (i.e., an angle of a transmittance axis of the front polarizer 126 is 90 degrees). The first quarter-wave plate QWP1, the first half-wave plate HWP1, the second quarter-wave plate QWP2, and the back polarizer 124 in FIG. 8B may be the same as the first quarter-wave plate QWP1, the first half-wave plate HWP1, the second quarter-wave plate QWP2, and the back polarizer 124 in FIG. 4, and the details thereof are not repeatedly described.

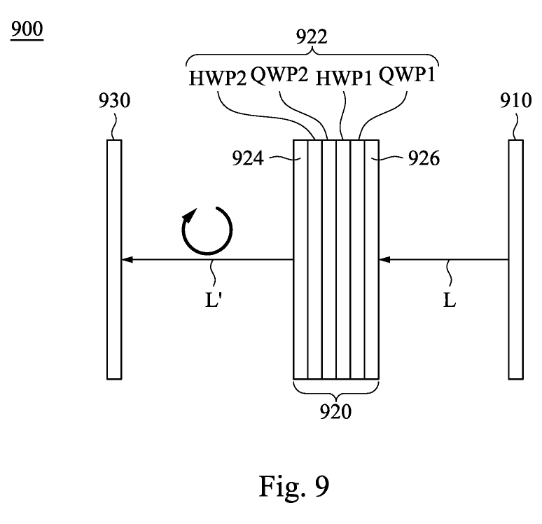

FIG. 9 is a schematic cross-sectional view of an optical device 900 in accordance with some embodiments of the present disclosure. The optical device 900 includes a display device 910, a polarization rotator 920, and an optic module 930. The polarization rotator 920 optically couples between the optic module 930 and the display device 910. The polarization rotator 920 includes a front polarizer 926, a wave plate assembly 922, and a back polarizer 924. The wave plate assembly 922 includes the first quarter-wave plate QWP1 having the optical axis oriented at the first angle, the first half-wave plate HWP1 having the optical axis oriented at the second angle, the second quarter-wave plate QWP2 having the optical axis oriented at the third angle, and the second half-wave plate HWP2 having the optical axis oriented at the fourth angle. The wave plate assembly 922 is between the front polarizer 926 and the back polarizer 924. The display device 910, the front polarizer 926, and the back polarizer 924 in FIG. 9 may be the same as the display device 110, the front polarizer 126, the back polarizer 124 in FIG. 7, and the details thereof are not repeatedly described. The optic module 930 in FIG. 9 may be the same as the optic module 130 in FIG. 1, and the details thereof are not repeatedly described.

In the embodiment of FIG. 9, the light L emits from the display device 910 is unpolarized. The optical device 900 may provide an unpolarized incident light L to the polarization rotator 920, and the unpolarized incident light L entering the polarization rotator 120 is output as an output light L’ as shown in FIG. 9. After passing through the polarization rotator 920, the polarization state of the light is converted to be circular, as shown in FIG. 9. In the embodiments of FIG. 9, the front polarizer 926 is a linear polarizer and the back polarizer 924 is a circular polarizer.

Referring to FIG. 1, the present disclosure provides a luminance and color compensation method, adapted to the optical device 100. The polarization rotator 120 has a first rotator area RA1 and a second rotator area RA2, the display device 110 includes the backlight module 112 and the display panel 114. The backlight module 112 includes a first backlight area BA1 corresponding to the first rotator area RA1 of the polarization rotator 120 and a second backlight area BA2 corresponding to the second rotator area RA2 of the polarization rotator 120. The luminance and color compensation method includes the following steps: emitting a light from the backlight module 112 to the display panel 114 and directing the light L from the display panel 114 to the polarization rotator 120.

At the step of emitting the light from the backlight module 112 to the display panel 114, the first backlight area BA1 of the backlight module 112 has a first backlight luminance and the second backlight area BA2 of the backlight module 112 has a second backlight luminance different from the first backlight luminance.

At the step of directing the light (i.e., the input light L) from the display panel 114 to the polarization rotator 120, the light (i.e., the output light L’) exiting the polarization rotator 120 has a first luminance in the first rotator area RA1 of the polarization rotator 120 and has a second luminance in the second rotator area RA2 of the polarization rotator 120, in which a ratio of a difference between the first luminance and the second luminance to the first luminance is less than a ratio of a difference between the first backlight luminance and the second backlight luminance to the first backlight luminance.

Referring to FIG. 1, the polarization rotator 120 further has a third rotator area RA3, and the backlight module 112 further includes a third backlight area BA3 corresponding to the third rotator area RA3 of the polarization rotator 120. At the step of emitting the light from the backlight module 112 to the display panel 114, the third backlight area BA3 of the backlight module 112 has a third backlight luminance. At the step of directing the light (i.e., the input light L) from the display panel 114 to the polarization rotator 120, the light (i.e., the output light L’) exiting the polarization rotator 120 has a third luminance in the third rotator area RA3 of the polarization rotator 120, in which a ratio of a difference between the first luminance and the third luminance to the first luminance is less than a ratio of a difference between the first backlight luminance and the third backlight luminance to the first backlight luminance.

Referring to FIG. 1, the display panel 114 includes a first panel area PA1 corresponding to the first rotator area RA1 of the polarization rotator 120 and a second panel area PA2 corresponding to the second rotator area RA2 of the polarization rotator 120. The luminance and color compensation method further includes the following step: controlling the display panel 114 such that the first panel area PA1 has a first color shift (or Gamma shift) and the second panel area PA2 has a second color shift different from the first color shift, in which the light (i.e., the output light L’) exiting the first rotator area RA1 and the second rotator area RA2 of the polarization rotator 120 has a greater brightness uniformity than a color uniformity of the light (i.e., the input light L) exiting the first panel area PA1 and the second panel area PA2 of the display panel 114.

Referring to FIG. 1, the display panel 114 further includes a third panel area PA3 corresponding to the third rotator area RA3 of the polarization rotator 120. The luminance and color compensation method further includes the following step: controlling the display panel 114 such that the third panel area PA3 has a third color shift different from the first color shift , in which the light (i.e., the output light L’) exiting the first rotator area RA1 and the third rotator area RA3 of the polarization rotator 120 has a greater brightness uniformity than the color uniformity of the light (i.e., the input light L’) exiting the first panel area PA1 and the third panel area PA3 of the display panel 114.

In summary, the polarization rotator of the optical device of the present disclosure includes a plurality of wave plates to optimize a polarization conversion efficiency of the polarization rotator, such that the image quality of the optical device can be improved and the user experience can be enhanced. The luminance and color compensation method adapted to the optical device of the present disclosure optimizes the brightness uniformity and color shift of the light emitted from the display device, such that the image quality of the optical device can be improved and the user experience can be enhanced.

The present disclosure has been disclosed as hereinabove, however it is not used to limit the present disclosure. Those skilled in the art may make various changes, substitutions, and alterations herein without departing from the spirit and scope of the present disclosure. Therefore, the scope of protection of the present disclosure shall be subject to the scope of the claims attached in the application and its equivalent constructions.

What is claimed is:

1. An optical device, comprising:
a display device emitting a light; and
a polarization rotator disposed in front of a light emitting surface of the display device and comprising:
a wave plate assembly comprising:
a first quarter-wave plate having an optical axis oriented at a first angle;
a first half-wave plate having an optical axis oriented at a second angle; and
a second quarter-wave plate having an optical axis oriented at a third angle, wherein the first half-wave plate is between the first quarter-wave plate and the second quarter-wave plate, and the second angle is different from the first angle and the third angle; and
a back polarizer, wherein the wave plate assembly is optically coupling between the back polarizer and the display device.

2. The optical device of claim 1, wherein the polarization rotator further comprises a front polarizer optically coupling between the display device and the wave plate assembly.

3. The optical device of claim 2, wherein an angle of a transmittance axis of the back polarizer added by 90 degrees is substantially equal to an angle of a transmittance axis of the front polarizer added by the first angle and the third angle.

4. The optical device of claim 2, wherein the light emitted from the display device is unpolarized.

5. The optical device of claim 1, wherein the light emitted from the display device is polarized, and an angle of a transmittance axis of the back polarizer added by 90 degrees is substantially equal to an angle of a polarization direction of the light emitted from the display device added by the first angle and the third angle.

6. The optical device of claim 1, wherein a difference between the first angle and the second angle is in a range from about 40 degrees to about 50 degrees, and a difference between the second angle and the third angle is in a range from about 40 degrees to about 50 degrees.

7. The optical device of claim 1, wherein a difference between the first angle and the second angle is substantially equal to a difference between the second angle and the third angle.

8. The optical device of claim 1, wherein the first angle is substantially equal to the third angle.

9. The optical device of claim 1, wherein the wave plate assembly further comprises:
a wave plate optically coupling the first quarter-wave plate, the first half-wave plate, and the second quarter-wave plate to the back polarizer.

10. The optical device of claim 9, wherein the wave plate is a second half-wave plate having an optical axis oriented at a fourth angle different from the first angle, the second angle, and the third angle.

11. The optical device of claim 1, wherein the light passing through the polarization rotator has a first phase retardation at a first wavelength and a second phase retardation at a second wavelength different from the first wavelength, the first wavelength and the second wavelength are in a range from about 400 nm to about 700nm, and a difference between the first phase retardation and the second phase retardation is less than about 5 degrees.

12. The optical device of claim 1, further comprising:
an optic module, wherein the wave plate assembly optically couples between the optic module and the display device.

13. The optical device of claim 1, wherein the light through the polarization rotator has a linear state of polarization.

14. The optical device of claim 13, wherein the back polarizer is a linear polarizer.

15. The optical device of claim 13, wherein the back polarizer is a circular polarizer.

16. The optical device of claim 1, wherein the light through the polarization rotator has a circular state of polarization.

17. The optical device of claim 1, wherein an in-plane retardation (R0) of each of the first quarter-wave plate and the second quarter-wave plate is in a range from 70 nm to 75 nm for wavelength 550 nm, and an in-plane retardation (R0) of the first half-wave plate is in a range from 140 nm to 150 nm for wavelength 550 nm.

18. The optical device of claim 1, wherein the polarization rotator is in contact with the light emitting surface of the display device.

19. A luminance and color compensation method, adapted to an optical device comprising a display device and a polarization rotator in front of a light emitting surface of the display device, wherein the polarization rotator has a first rotator area and a second rotator area, the display device comprises a backlight module and a display panel, and the backlight module comprises a first backlight area corresponding to the first rotator area of the polarization rotator and a second backlight area corresponding to the second rotator area of the polarization rotator, the method comprising:
emitting a light from the backlight module to the display panel, wherein the first backlight area of the backlight module has a first backlight luminance and the second backlight area of the backlight module has a second backlight luminance different from the first backlight luminance; and
directing the light from the display panel to the polarization rotator, wherein the light exiting the polarization rotator has a first luminance in the first rotator area of the polarization rotator and has a second luminance in the second rotator area of the polarization rotator, wherein a ratio of a difference between the first luminance and the second luminance to the first luminance is less than a ratio of a difference between the first backlight luminance and the second backlight luminance to the first backlight luminance.

20. The luminance and color compensation method of claim 19, wherein the display panel comprises a first panel area corresponding to the first rotator area of the polarization rotator and a second panel area corresponding to the second rotator area of the polarization rotator, and the method further comprises:
controlling the display panel such that the first panel area has a first color shift and the second panel area has a second color shift different from the first color shift, wherein the light exiting the first rotator area and the second rotator area of the polarization rotator has a greater brightness uniformity than a color uniformity of the light exiting the first panel area and the second panel area of the display panel.
